(19) United States
(12) Patent Application Publication
(10) Pub. No.: US 2011/0233869 A1
(43) Pub. Date: Sep. 29, 2011

(54) BALLISTIC PANELING FOR BULLET TRAPS

(76) Inventors: Ernest M. John, American Fork, UT (US); David Bassett, Provo, UT (US); Chris Ream, Orem, UT (US)

(21) Appl. No.: 13/053,028

(22) Filed: Mar. 21, 2011

Related U.S. Application Data
(60) Provisional application No. 61/317,567, filed on Mar. 25, 2010.

(51) Int. Cl. F41J 13/00; B32B 37/02; B32B 37/14; B23P 17/04

(52) U.S. Cl. 273/410; 156/60; 29/428

(57) ABSTRACT

A ballistic wall includes a facing material having destructible material with at least one side having a resilient material attached thereto to help provide additional integrity to the wall and to reduce the risk of ricocheting projectiles passing through the facing material.

### RELATED APPLICATION

The present application claims the benefit of U.S. Provisional Patent Application Ser. No. 61/317,567, filed Mar. 25, 2010, which is expressly incorporated herein.

### BACKGROUND OF THE INVENTION

1. Field of the Invention

The present invention relates to an improved ballistic paneling for use in bullet traps, to bullet traps using such ballistic paneling and to methods of making the same. More particularly, the present invention relates to destructible paneling which is coated with a resilient member (commonly referred to as self-healing or semi self-healing rubber) to prolong the life of the destructible medium, and to bullet traps using such destructive paneling and methods of making the same.

2. Background

There are a variety of reasons for which individuals engage in shooting. Many individuals will shoot to improve their proficiency in hunting. Law enforcement officials, however, must shoot on a regular basis to maintain their proficiency in the use of firearms so as to ensure their skills and promote safety. A police officer who regularly engages in target practice, particularly in lifelike scenarios, is more likely to make proper decisions when faced with the risk of harm, such as an individual holding an item which may or may not be a weapon, and to shoot accurately under high stress conditions. Additionally, thorough training of law enforcement personnel and military helps to teach them methods for properly clearing structures in environments which pose a risk. The training helps the officers/military personnel to maintain a safer environment by ensuring proper technique and minimizing the risk that an officer/military member will make an inaccurate assessment of a threat situation and accidentally injure or kill himself or a third party.

One method for training law enforcement officers and military is the use of what is commonly called a shoot house. A shoot house typically allows 360 degree live fire so that the officer, soldier, etc. may be placed in a realistic environment and presented with various threats that are similar to those which would be faced in the field. These could involve, for example, a domestic violence situation in which a target representing a suspect has a gun, or a hostile fire situation for military personnel where several targets representing terrorists are disposed within the shoot house so that the military personnel can train on how to safely clear the house with minimal threat to themselves and their colleagues.

Shoot houses have been formed in a plurality of ways. Early shoot houses were formed out of stacked tires or boxes of ballistic decelerating material such as sand. While tires and sand are good at decelerating bullets, they do not provide a lifelike scenario. Significant improvements were made in realistic looking shoot houses with the invention disclosed in U.S. Pat. No. 5,822,936. FIG. 1A shows a fragmented view of a ballistic wall, generally indicated at 10, made in a similar manner. Steel panels 14 are attached together (typically with a facing strip 16 and a backing strip 18 with bolts 20 holding the structure together). Two-by-fours 22 or similar structures are attached to the steel panels (or the facing strip covering a joint between the panels). A facing material such as plywood sheets 24, sheet rock, etc. is then attached to the two-by-fours 22 so as to cover the two-by-fours and the steel panels 14, with the facing material spaced apart from the steel panels several inches. A bullet fired in the shoot house will pass through the wood and impact against the steel plates to stop its forward momentum. The facing material 24 helps to prevent back splatter or ricochets from passing back to the shooter or other people nearby.

While shoot houses with such a construction have been highly popular, one aspect of maintenance is replacing the facing material 24 as it is destroyed due to thousands of shots being fired. As plywood or similar facing materials are shot repeatedly, small holes are made. Over time, concentrated shooting can leave large holes and the facing material must be changed to prevent ricochets escaping out these holes and possibly injuring the shooters or others nearby.

Another embodiment of a ballistic wall used in shoot houses and other environments includes steel walls 40 to which are attached rubber-like blocks or sheets 42 as shown in FIG. 1B. The rubber-like material may be such as sheets of a “self-healing” or resilient materials such as natural or virgin rubber, (sheets of primarily natural rubber are sold under the trademark LINATEX (Abrasion Resistant Rubber, available from Linatex Inc. 1550 Airport Rd Gallatin, Tenn.)), blocks of compressed tire grindings, EDPM (ethylene propylene diene Monomer (M-class) rubber) commonly used as roofing material, or a variety of similar materials. The rubber 42 is effective at containing splatter from bullets, and the steel walls 40 behind the rubber ensure that the bullets are brought to a complete halt. Such ballistic walls, however, can create bullet masses in a small area when there is localized firing. Lead bullets can fuse together making ever larger clumps of lead. This can create a ricochet risk and generally requires the rubber material to be replaced. Additionally, such ballistic walls tend to be relatively expensive.

One embodiment of a ballistic wall used in shoot houses and otherwise as a backstop for target practice is a built similar to the configuration shown in FIG. 1A, except that the void between the facing material 24 and the steel panels 14 is filled with gravel, chopped rubber, or other bullet deceleration medium 50. The deceleration medium 50 helps to decelerate a bullet or other projectile so that the ballistic wall can be used with higher power rounds.

Gravel is a preferred material for use as the deceleration medium 50 because it is inexpensive, easy to obtain, and decelerates the bullet significantly in a very short distance. One maintenance concern with gravel, however, is that as it vibrates it tends to abrade the wood and necessitates replacement of the wood more frequently than would be desired. Additionally, if shooting is concentrated in one area, small pieces of gravel can begin to fall out through the holes.

One improvement to such a wall was achieved by Action Target Inc. of Provo, Utah as shown in FIG. 1C. Sheets of a “semi-self-healing” or resilient material 54, such as EPDM (ethylene propylene diene Monomer (M-Class) rubber) were placed behind the facing material 24. As bullets passed through the plywood, etc., and the EPDM, holes are formed. However, the resilient nature of the EPDM causes the holes to shrink to a size substantially smaller than the diameter of the bullet. Thus, EPDM remains in place to inhibit gravel falling out of the ballistic wall even when a larger hole has been formed in the plywood or other facing material 24. Additionally, the EPDM has also been found to reduce abrasion on the facing material 24 by the gravel 50.

Similarly, FIG. 1D shows a target 60 made by Action Target which is often used in shoot houses at locations where there is expected to be a high volume of firing. Thus, the target 60 reduces wear on the walls of a shoot house and can be moved and reconditioned much more easily that the walls of the shoot house itself. The target 60 includes a steel panel 14, two-by-fours 22 or other spacing material, and a facing material 24 such as plywood. To help reduce the risk of back splatter in any weakened area of the facing material 24, a sheet of natural or virgin rubber or primarily rubber material such as LINATEX brand rubber (silica reinforced rubber) sheathing 64 (collectively referred to as “rubber”) can be used adjacent the back of the facing material Rounds passing through the facing material 24 passes through the rubber, which resiliently reduces the size of the hole. Thus, the plywood of the face material degrades faster than the rubber and the rubber inhibits bullet fragments from passing out of any holes in the plywood.

While each of these embodiments has their respective advantages and disadvantages, there is a desire for a relatively inexpensive ballistic paneling and ballistic wall which has greater durability. While all of these embodiments of shoot houses have improved the ability to train law enforcement and military personnel, most suffer the problem that the wood panels must be replaced frequently under heavy use conditions. This requires additional money as well as time spent replacing the panel and refilling the wall with gravel, etc Likewise, rubber blocks and sheets of rubber-like material are expensive and time consuming to replace. Thus, there is a need for a ballistic wall which will better survive high volume shooting so as to minimize maintenance, and preferably, to reduce cost.

### SUMMARY OF THE INVENTION

It has been found in accordance with the principles of the present invention that one or more layers of a resilient material may be bonded or otherwise affixed to the facing material, such as plywood. This may be done with an adhesive material, such as liquid nails, or other bonding procedures. The sheets of resilient material close holes formed by the bullets to thereby hold any gravel or other deceleration material in place. Additionally, it has been found that having the resilient material bonded to the facing material helps to reduce the amount of wood which is destroyed as a bullet passes through and keeps pieces of wood attached longer as they are provided secondary means of support.

In accordance with another aspect of the invention, resilient sheets are bonded to the facing material on both sides. Thus, the wood is essentially sandwiched between the resilient material. As bullets are fired through the material coated facing material made of wood, it has been found that much less wood is lost as most broken pieces of wood remain bound or held between the resilient sheets. Thus, when multiple rounds are fired in a small area, a hole does not develop in the wood as is common with the prior art. Rather, a soft spot will develop between the sheets of resilient material, but small wood fragments remains trapped by the two pieces of resilient material. Thus, not only does the remaining wood help, to some extent, to decelerate the bullet as it passes through the facing material, it also significantly reduces the chance of any back splatter or ricochet coming back toward the shooter because any bullet fragments must pass back through the inner sheet of resilient material, the wood pieces and the outer sheet of resilient material before it could reach a shooter or other person nearby.

Based on preliminary tests, it is believed that a facing sheet constructed in accordance with the present invention will survive at least 10 times the number of rounds as a conventional piece of plywood prior to needing to be replaced. Even when a relatively firm piece of material that is still resilient as to closing any holes formed by the bullet is used, the panel will apparently withstand up to as many as 100 times the number of rounds before the plywood or other facing material must be replaced. Thus, even though the facing material is more expensive than a traditional sheet of plywood, the overall cost of operating the range is reduced as the facing sheets may need to be replaced much less often. Additionally, there is a substantial savings in labor as the panels do not need to be pulled off, any gravel or other deceleration medium cleaned out, the panel replaced, and refilled with deceleration medium as is common with many traps. Thus, the present invention provides a ballistic wall which is believed to be safer and has lower long term operating costs than many currently available ballistic walls.

### BRIEF DESCRIPTION OF THE DRAWINGS

Various embodiments of the present invention are shown and described in reference to the numbered drawings wherein:

FIG. 1A shows a fragmented cross-sectional view of a ballistic wall made in accordance with the principles of the prior art;

FIG. 1B shows a fragmented cross-sectional view of an alternate embodiment of a ballistic wall made in accordance with the teachings of the prior art;

FIG. 1C shows a fragmented cross-sectional view of yet another embodiment of a ballistic wall made in accordance with the teachings of the prior art;

FIG. 1D shows a fragmented cross-sectional view of yet another embodiment of a ballistic wall made in accordance with the teachings of the prior art.

FIG. 2 shows a fragmented cross-sectional view of a ballistic wall made in accordance with principles of the present invention;

FIG. 3 shows a close-up cross-sectional view of a section of the wall of FIG. 2 which has been penetrated by a large number of projectiles;

FIG. 4 shows a close-up front view of a piece of facing material made in accordance with the principles of the present invention; and

FIG. 5 shows an alternate embodiment of the invention wherein only a portion of the facing material is covered with resilient material.

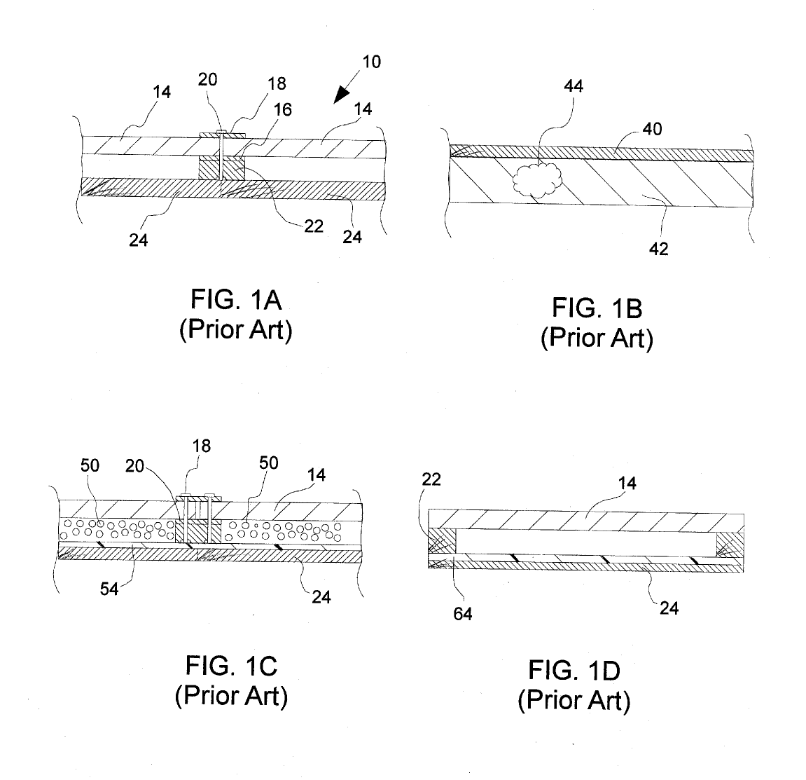

It will be appreciated that the drawings are illustrative and not limiting of the scope of the invention which is defined by the appended claims. The various elements of the invention accomplish various aspects and objects of the invention. It is appreciated that not every element of the invention can be clearly displayed in a single drawing, and as such not every drawing shows each element of the invention.

### DETAILED DESCRIPTION

The drawings will now be discussed in reference to the numerals provided therein so as to enable one skilled in the art to practice the present invention. The drawings and descriptions are exemplary of various aspects of the invention and are not intended to narrow the scope of the appended claims.

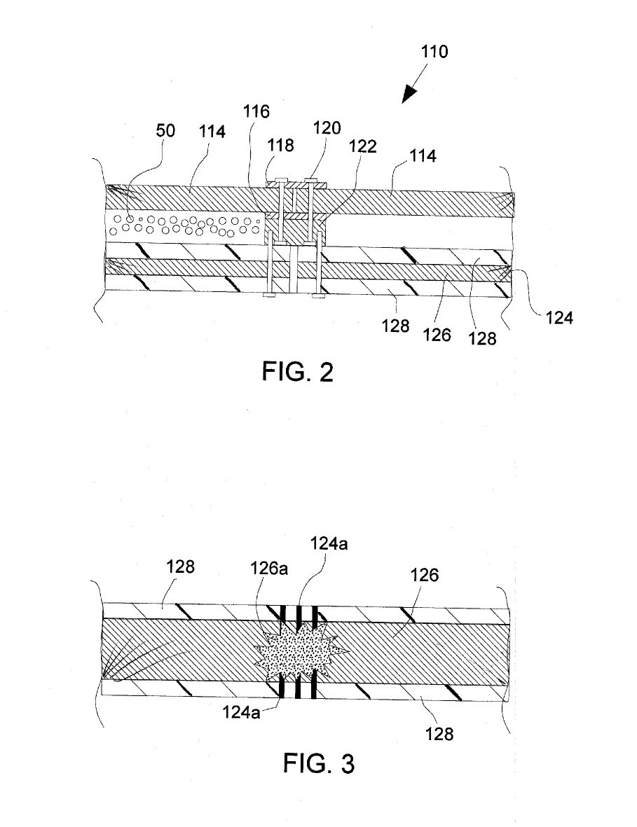

Turning now to FIG. 2, there is shown a cross-sectional view of a ballistic wall 110 made in accordance with the principles of the present invention. The wall is formed by one or more steel plates 114. If multiple plates are used, a facing strip 116 and a backing strip 118 are typically used to cover the joint formed by the plates, though other attachment mechanisms can be used. Bolts 120 may be used to hold the facing strip 116 and the backing strip 118 to the plates 114. One of more of the bolts 120 may also be used to hold a spacer 122, such as a two-by-four or a U-shaped metal channel, to the facing strip 116 and/or the plates 114. Facing sheets 124 are attached to the spacer 122 to provide a medium which the bullet must pass through before striking the plates 114 and to provide a barrier against ricochets and back splatter. The facing material 124 includes at least one sheet of a destructible material 126, such as plywood, oriented strand board, sheet rock, gypsum board, or the like. On at least one side of the destructible material 126, one or more sheets of resilient material 128 is bonded to the destructible material. The bonding can include gluing or any of a number of other attachment techniques.

The resilient material may be selected from a wide variety of materials. Two materials which have been found to be particularly useful are EPDM, a material commonly used in roofing, and rubber, such as natural or virgin rubbers, or similar material such as LINATEX, which are used as “self-healing rubbers” in ballistic applications. EPDM sheets 2 mm in thickness were bonded to pieces of plywood using contact cement and heat activated adhesive. In each case the ballistic panel formed by the plywood and EPDM had a much greater life than a plywood panel alone. This was particularly true where the EPDM was attached on both sides of the plywood.

Likewise, ballistic panels were made using plywood and sheets of rubber in 2 mm, 4 mm and 6 mm thicknesses. (Other thickness, such as 8 mm could also be used) The sheets were bonded using contact cement and heat activated adhesives. While the 6 mm rubber provided the best wear resistance, each sample showed a marked improvement above plain plywood. Where the plywood was sandwiched between the resilient material, the ballistic panels showed a remarkable improvement in wear resistance.

By having the resilient material 128 bonded to the destructible material 126, the resilient material helps to minimize destruction of the destructible material caused by the bullet passing therethrough. For example, repeated shots at a piece of plywood will cause pieces of the plywood to brake off even if that piece is not directly impacted by the round. By having the plywood bonded to the resilient material or sandwiched between pieces of resilient material, the piece of plywood may stay in place even if it actually breaks off of the larger piece of plywood. The piece can then be impacted by subsequent bullets and provide a deceleration for further rounds.

In a presently preferred embodiment, both sides of the destructible material 126 are bonded or otherwise secured to sheets of resilient material 128. While the projectile will carry some of the wood, etc., through the resilient material, pieces of the destructible material which are broken off but not carried by the bullet remain between the sheets of resilient material. This provides a facing material which still helps to reduce the risk of ricochets or back splatter injuring anyone as compared to a hole in a piece of wood. In tests, an area of wood sandwiched by resilient material was shot at 100 times. In normal shoot house panels, a large hole would have been left, necessitating replacement of the panel. However, while the wood was pulverized, it was maintained between the sheets of resilient material, obviating the need to replace the panel.

In a presently preferred embodiment, the destructible material 126 is plywood between ½ and ¾ inches thick, although other thicknesses may be used. Bonded or otherwise attached to each side of the plywood are sheets of resilient material, such as EPDM or rubber between 1/16^{th} and ¼^{th} inch thick (i.e. about 2 mm to 6 mm). It will be appreciated that by “resilient” it is meant that the material will tend to at least partially close a hole formed by a projectile passing through. Preferably, the resiliency will close the hole by at least 50 percent, more preferably by 75 percent and most preferably by at least 90 percent. Thus, the resilient material at least partially closes up the holes caused by the projectiles. This keeps the gravel 50 or other deceleration medium in place if gravel or other deceleration medium is used (as shown in the left half of FIG. 2). The sealed holes also help prevent small shrapnel from coming back through holes in the destructible material 126, such as plywood, even if gravel or other deceleration medium is not used (as shown on the right half of FIG. 2).

Turning to FIG. 3, there is shown a close-up view of the facing material 124 after a large number of rounds have been fired though in a small area 124a. While the plywood forming the destructible material 126 has been turned to little more than saw dust or small chucks of wood 126a, the wood fibers remain held between the sheets of resilient material 128. Thus, while a soft spot is left in the facing material 124, the sheets of resilient material 128 have substantially sealed off the entrance and exit wounds of the projectiles and there is virtually no hole through which a projectile fragment can come back at the shooter. The remaining plywood 126, etc., can help support the soft spot. Additionally, even if a bullet passes through the soft spot, it is still decelerated more than it would be by simply passing through a sheet of resilient material.

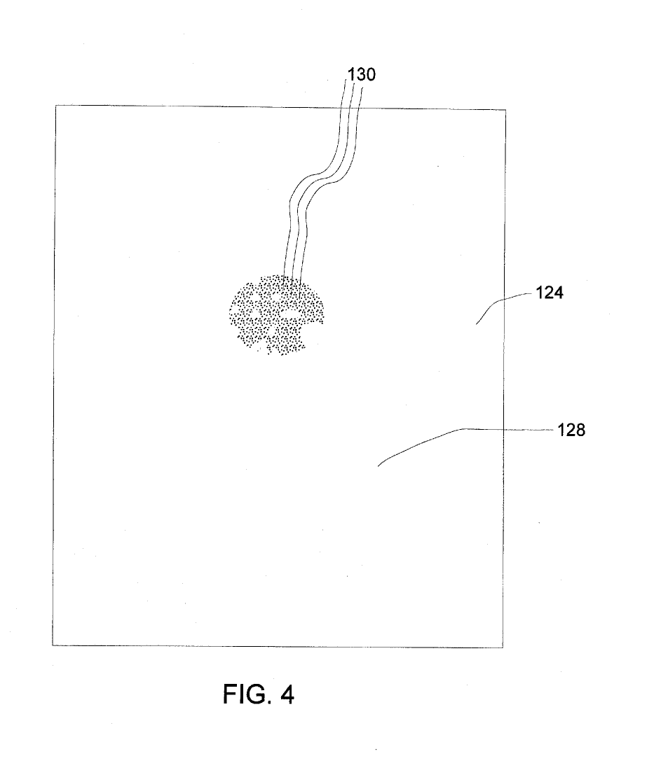

FIG. 4 shows a front view of the resilient material 124 with a large number of puncture marks 130 through the outer resilient sheet 128. With a conventional plywood facing, a large number of rounds would form a hole where no wood would be left. Additionally, without a backing, any gravel or other deceleration medium could fall out of the hole. In contrast, the present invention lacks any large holes and most of the wood which has been pulverized by the projectiles remains between the sheets of resilient material.

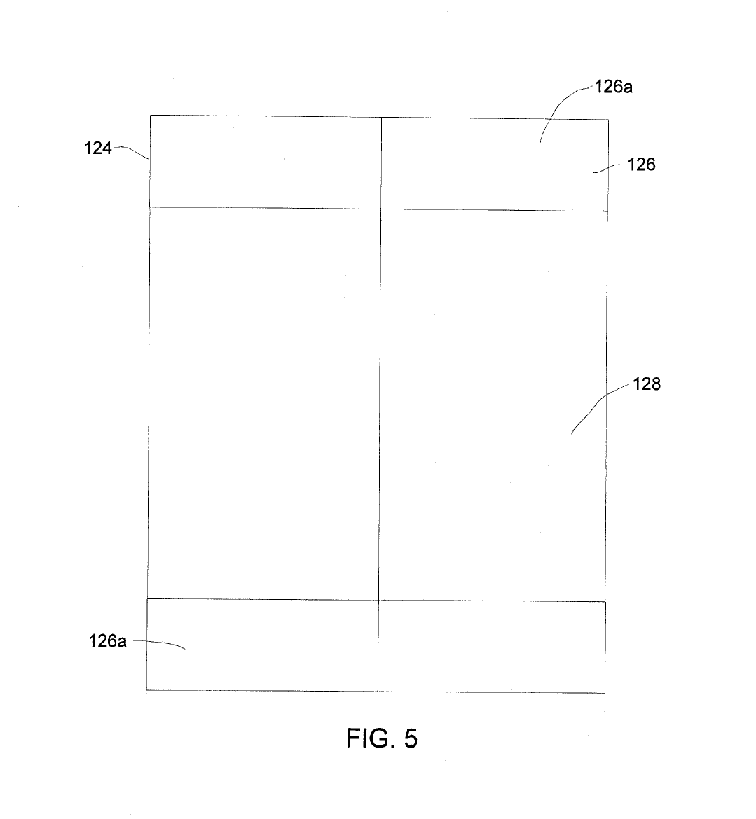

Turning now to FIG. 5, there is shown an alternate application of the invention. While it is presently preferred to have the entire surface of both sides of the destructible material 126 covered with the sheets of the resilient material 128, a lower cost option would be to cover portions of the destructible material 126 which are likely to receive a large amount of projectiles, while leaving portions which are less likely to sustain a large number of rounds uncovered. Thus, for example, a space 126b could be left at the top and bottom of the plywood where the resilient material is not present, as the top 18-24 inches and bottom 18-24 inches often sustain less fire than the middle portion. Depending on the price of the resilient material and the amount of space left uncovered, this could reduce the cost of each panel by nearly 50 percent while still providing coverage for areas of the panel which are likely to sustain high volume shooting.

There is thus disclosed an improved ballistic panel for use on shoot houses and other bullet containment systems. It will be appreciated that numerous changes may be made to the present invention without departing from the scope of the claims. The appended claims are intended to cover such modifications.

What is claimed is:

1. A facing material for a ballistic wall, the facing material comprising:
a destructible material for being penetrated by a projectile; and
at least one sheet of resilient material bonded to the destructible material.

2. The facing material of claim 1, wherein the destructible material is plywood.

3. The facing material of claim 2, wherein the at least one sheet of resilient material is EPDM.

4. The facing material of claim 2, wherein the at least one sheet of resilient material is rubber.

5. The facing material of claim 2, wherein the plywood has opposing sides and wherein sheets of the resilient material are bonded to the opposing sides.

6. The facing material of claim 1, wherein the destructible material is between ½ and ¾ths of an inch.

7. The facing material of claim 1, wherein the at least one sheet of resilient material is between about 2 mm and 6 mm thick.

8. The facing material of claim 1, wherein the destructible material is selected from the group consisting of plywood and oriented strand board, and wherein the resilient material is self-healing rubber and wherein the destructible material has opposing sides and the self-healing rubber is attached to both of the opposing sides.

9. The facing material of claim 1, wherein the destructible material is bonded to the resilient material by contact cement.

10. The facing material of claim 1, wherein the destructible material is bonded to the resilient material by a heat activated adhesive.

11. A ballistic wall comprising:
at least one steel plate;
at least one facing material spaced apart from the at least one steel plate, the at least one facing material comprising at least one sheet of destructible material and at least one sheet of resilient material bonded to the at least one sheet of destructible material.

12. The ballistic wall of claim 11, wherein the at least one sheet of destructible material is plywood having a first side and a second side, and wherein the at least one sheet of resilient material comprises a first sheet of resilient material attached to the first side and at least one sheet of the resilient material attached to the second side.

13. The ballistic wall of claim 12, wherein at least one of the sheets of resilient material substantially covers all of the sheet of the plywood.

14. The ballistic wall of claim 11, wherein the at least one sheet of resilient material is selected from EPDM and rubber.

15. The ballistic wall of claim 11, wherein the at least one sheet of destructible material comprises at least one sheet of a destructible material selected from the group consisting of plywood and oriented strand board, sheet of material having a front side and a rear side and wherein the at least one sheet of resilient material comprises a sheet of rubber disposed on the front side and a sheet of rubber disposed on the rear side of the destructible material.

16. The ballistic wall of claim 11, wherein the at least one sheet of destructible material comprises at least one sheet of a destructible material selected from the group consisting of plywood and oriented strand board, sheet of material having a front side and a rear side and wherein the at least one sheet of resilient material comprises a sheet of EPDM disposed on the front side and a sheet of EPDM disposed on the rear side of the destructible material.

17. The ballistic wall of claim 11, wherein the resilient material is between about 2 mm and 6 mm.

18. A method for making a ballistic panel, the method comprising:
selecting a sheet of destructible medium; and
bonding a sheet of resilient material to the destructible material so as to cover at least part of one side of the destructible material.

19. The method according to claim 18, wherein the method comprises bonding sheets of resilient material to opposing sides of the destructible material.

20. The method according to claim 18, wherein the resilient material comprises self-healing rubber or partially self-healing rubber and wherein the destructible material is selected from particle board and oriented strand board.

21. A method for making a ballistic wall, the method comprising:
selecting a piece of metallic plate;
selecting a piece of facing material having a sheet of destructible material and at least one sheet of resilient material bonded to the destructible material; and
attaching the facing material to the piece of metallic plate so that the facing material is spaced forward of the metallic plate so as to leave a bullet containment area between the metallic plate and the facing material.

22. The method according to claim 21, wherein the sheet of destructible material has a front side and a rear side and wherein the facing material has a sheet of resilient material attached to a front side of the destructible material and a sheet of resilient material attached to a rear side of the destructible material.

23. A facing material for use in a bullet containment system, the facing material comprising at least one sheet of destructible material selected from the group consisting of plywood and oriented strand board, a layer of resilient material attached to one side of the destructible material and a layer of resilient material attached to an opposing second side of the destructible material.
